(19) United States
(12) Patent Application Publication
(10) Pub. No.: US 2010/0219705 A1
(43) Pub. Date: Sep. 2, 2010

(54) COOLING APPARATUS FOR ELECTRIC MOTOR

(75) Inventors: AN-ZHENG YANG, Tu-Cheng (TW); YIN-JAO LUO, Tu-Cheng (TW); SHAO-CHUNG YUAN, Tu-Cheng (TW); YI-CHENG SU, Tu-Cheng (TW); CHIA-CHING LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/430,125

(22) Filed: Apr. 27, 2009

(30) Foreign Application Priority Data
Feb. 27, 2009 (CN) 200910300611.7

(51) Int. Cl. H02K 9/19

(52) U.S. Cl. 310/54

(57) ABSTRACT

A cooling apparatus for an electric motor includes a mount to be fixed to and abutted against the electric motor, and a cooling unit installed to the mount. The mount defines at least two channels. The cooling unit connects adjacent said at least two channels to form a passage to allow a cooling fluid flowing in the passage.

### BACKGROUND

1. Technical Field

The present disclosure relates to cooling apparatus and, more particularly, to a cooling apparatus for an electric motor.

2. Description of Related Art

An electric motor transforms electromagnetic energy to mechanical energy. Because a substantial part of the electromagnetic energy is inevitably transformed into heat energy, a temperature of the electric motor rises when the electric motor works. Therefore, a heat dissipating means is required to prevent the electric motor from overheating. A fan is typically installed to the electric motor for dissipating the heat. However, by using a fan, the heat is transferred by airflow which is not very efficient.

### BRIEF DESCRIPTION OF THE DRAWINGS

FIG. 1 is an exploded, isometric view of a first exemplary embodiment of a cooling apparatus.

FIG. 2 is an assembled view of the cooling apparatus of FIG. 1.

FIG. 3 is an assembled view of the cooling apparatus of FIG. 2, and an electric motor.

FIG. 4 is an assembled, isometric view of a second exemplary embodiment of a cooling apparatus.

### DETAILED DESCRIPTION

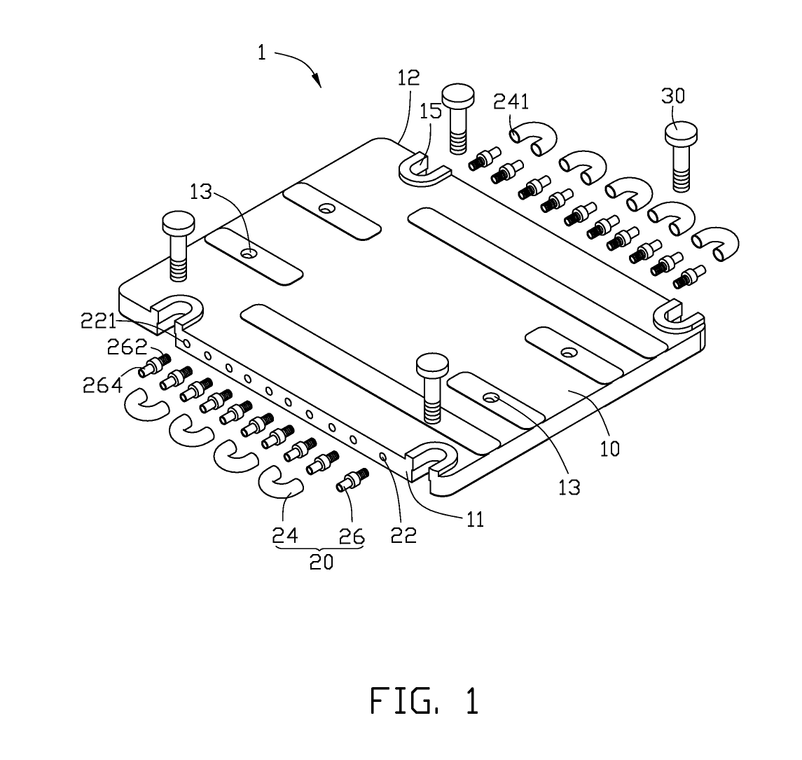

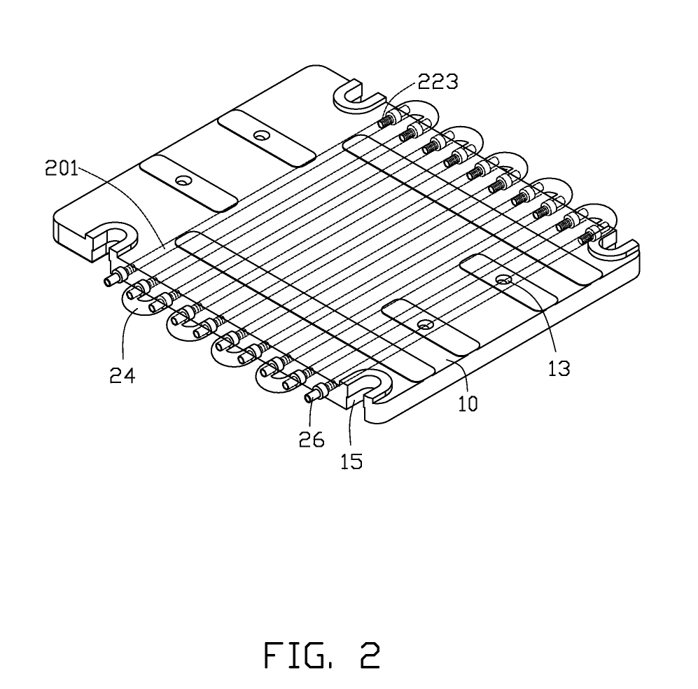

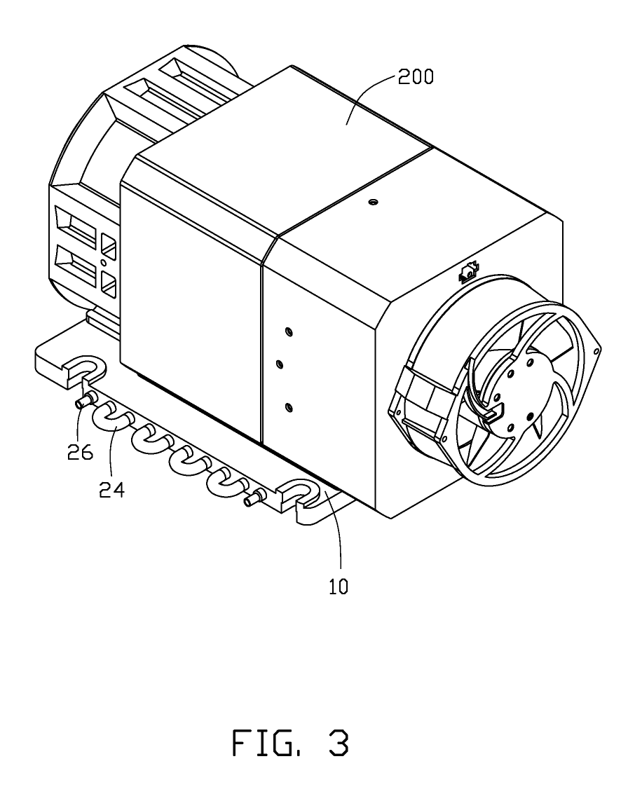

Referring to FIGS. 1 to 3, a first exemplary embodiment of a cooling apparatus 1 includes a mount 10 to be fixed to the electric motor 200, a cooling unit 20 to be installed to the mount 10 and four fasteners 30.

The mount 10 is a substantially rectangular plate. The mount 10 defines a plurality of fixing holes 13 in a middle area of the mount 10, and four substantially U-shaped securing slots 15 adjacent to four corners of the mount 10 correspondingly. A plurality of parallel channels 22 is defined in the mount 10, through a first lateral side 11 to a second lateral side 12 opposite to the first lateral side 11 of the mount 10. Each of the plurality of channels 22 includes two opposite openings 221 defined in the first and second lateral sides 11, 12 of the mount 10, and forms two threaded portions 223 on an inner wall bounding the channel 22 adjacent to the openings 221 of the channel 22, respectively.

In one embodiment, the cooling unit 20 includes a plurality of U-shaped connecting tubes 24, and a plurality of hollow tube fittings 26. Each of the plurality of tube fittings 26 includes a threaded engaging portion 262 and a connecting portion 264 at opposite ends of the tube fitting 26, respectively. The engaging portions 262 of the plurality of tube fittings 26 are inserted into the channels 22 through the openings 221 of the plurality of channels 22 respectively, and engaged with the threaded portions 223 of the plurality of channels 22 correspondingly. Each of the plurality of connecting tubes 24 includes two opposite distal ends 241. The connecting portions 264 are configured to be securely fitted in the connecting tubes 24 through the distal ends 241, correspondingly.

In assembly, the engaging portions 262 of the plurality of tube fittings 26 are inserted into the plurality of channels 22 and engaged with the threaded portions 223 of the plurality of channels 22, correspondingly. The distal ends 241 of each of the plurality of connecting tubes 24 are respectively connected to the connecting portions 264 of two adjacent tube fittings 26 by securely fitting the connecting portions 264 in the connecting tube 24. Therefore, the plurality of channels 22 is connected in sequence via the plurality of the connecting tubes 24 and the plurality of tube fittings 26, to provide a passage 201 for a cooling fluid. The connecting portions 264 of two tube fittings 26 on opposite ends of a passage 201 are exposed out of the mount 10, to function as an entry and an exit for the cooling fluid. The mount 10 is fixed to and closely abutted against a bottom of the electric motor 200 by a plurality of screws (not shown in the drawings) passing through the plurality of fixing holes 13 of the mount 10 to engage in corresponding screwing holes (not shown in the drawings) defined in the bottom of the electric motor 200. The mount 10 is retained to a floor or a platform via the fasteners 30 extending through the securing slots 15 to be fixed in corresponding portions of the floor or the platform.

In use, the cooling fluid is injected into the plurality of passages 201 through the entry of the passage 201. The cooling fluid absorbs heat generated by the electric motor 200 during flowing through the passage 201, and is exhausted out of the passage 201 via the exit of the passage 201. Heat dissipating for the electric motor 200 is carried out via the cooling fluid flowing in the passage 201.

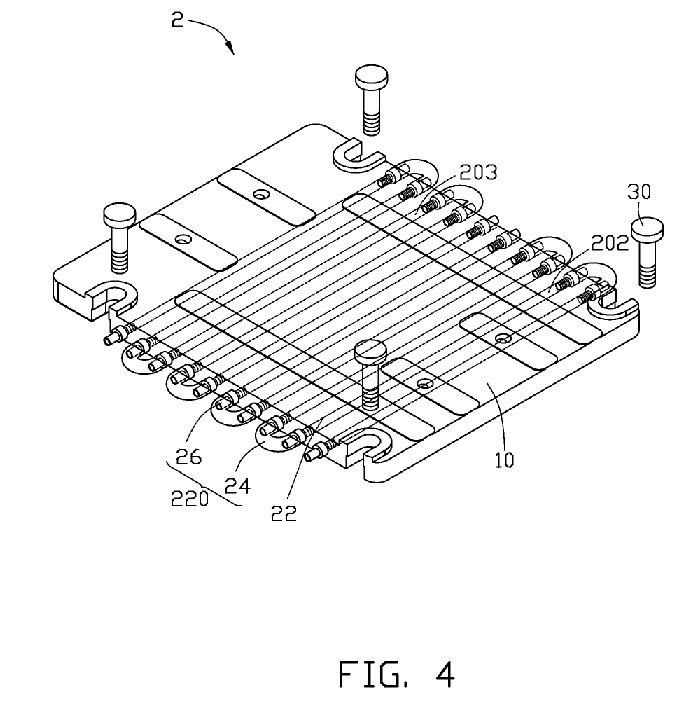

FIG. 4 shows a cooling apparatus 2 in accordance with a second exemplary embodiment of present disclosure. The cooling apparatus 2 includes a mount 10 similar to the mount 10 of the first embodiment, and a cooling unit 220. The cooling unit 220 includes a plurality of U-shaped connecting tubes 24, and a plurality of hollow tube fittings 26. The cooling apparatus 2 is assembled in a way similar to the cooling apparatus 1. But the cooling apparatus 2 in an assembled state includes two passages 202 and 203, by omitting a connecting tube 24 in a middle of the passage 201 of the mount 1.

In other embodiments, the cooling unit 20 may be differently formed or structured. For example, the cooling unit 20 may be a heat conducting pipe embedded in the mount 10 for the cooling fluid flowing therein.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cooling apparatus to be fixed to an electric motor, the mount comprising:
a mount to be abutted against the electric motor and defining at least two channels; and
a hollow cooling unit installed to the mount and connected to adjacent said at least two channels to form a passage to allow a cooling fluid flowing in the passage.

2. The cooling apparatus of claim 1, wherein said at least two channels comprise a plurality of channels, each of the plurality of channels defines two openings in opposite lateral sides of the mount; the cooling unit comprises:
a plurality of hollow connecting tubes, wherein each of the plurality of connecting tubes comprises two opposite distal ends; and
a plurality of hollow tube fittings, wherein each of the plurality of tube fittings forms an engaging portion, and a connecting portion at opposite ends of the tube fittings;
wherein the engaging portions of the plurality of tube fittings are connected to the openings of the corresponding channels, and the connecting portions are connected to the distal ends of the corresponding connecting tubes, therefore, the plurality of channels is connected in sequence via the plurality of connecting tubes and tube fittings to form the passage for the cooling fluid.

3. The cooling apparatus of claim 2, wherein two threaded portions are formed on an inner wall bounding each of the plurality of channels, adjacent to the corresponding openings of the channels respectively.

4. The cooling apparatus of claim 3, wherein the engaging portions of the plurality of tube fittings are structured to be inserted into the plurality of channels through the openings to engage with the threaded portions of the plurality of channels, correspondingly.

5. The cooling apparatus of claim 2, wherein the connecting portions of the plurality of tube fittings are extended into and engaged with the plurality of connecting tubes via the distal ends of plurality of the connecting tubes, correspondingly.

6. The cooling apparatus of claim 2, wherein each of the plurality of connecting tubes is U-shaped.

7. The cooling apparatus of claim 6, wherein each of the plurality of connecting tubes is connected to two neighboring tube fittings.

8. The cooling apparatus of claim 2, wherein the mount is a substantially rectangular plate, the plurality of channels is straight and parallel to one another.

9. The cooling apparatus of claim 1, further comprising four fasteners, wherein the mount defines four securing slots adjacent to four corners of the mount, respectively, the fasteners are structured and arranged to be engaged in the securing slots of the mount to support the electric motor.

10. The cooling apparatus of claim 6, wherein each of the plurality of connecting tubes is connected to two neighboring tube fittings, except that one pair of two neighboring tube fittings are not connected with a tube.
